(19) United States
(12) Patent Application Publication
(10) Pub. No.: US 2008/0107309 A1
(43) Pub. Date: May 8, 2008

(54) Method and apparatus for biometric identification

(75) Inventor: Todd A. Cerni, Mead, CO (US)

Correspondence Address: PATTON BOGGS LLP, 1801 CALFORNIA STREET, SUITE 4900, DENVER, CO, 80202, US

(73) Assignee: Cerni Consulting, LLC, Mead, CO (US)

(21) Appl. No.: 11/725,104

(22) Filed: Mar. 16, 2007

Related U.S. Application Data
(60) Provisional application No. 60/856,576, filed on Nov. 3, 2006.

(51) Int. Cl. G06K 9/00

(52) U.S. Cl. 382/115

(57) ABSTRACT

The invention describes the first practical, cost effective, truly non-contact implementation of a subcutaneous vein pattern biometric sensor. A laser diode (LD) illuminates the hand in such a way that the pattern of reflected radiation, when viewed by a conventional vein pattern infrared imager, provides a direct measure of target range. Said target range measurement is used to create a visual or audio signal that instructs the individual being scanned to place the hand at precisely the optimum range, such that the vein pattern is in focus. Furthermore, a system and apparatus are described to direct the individual being scanned to move the hand to an optimal horizontal registration or position with respect to the infrared imager.

### CROSS-REFERENCE TO RELATED APPLICATIONS

This Application is a Non-Provisional of Provisional (35 USC 119(e)) Application No. 60/856,576 filed on Nov. 3, 2006.

### FIELD OF THE INVENTION

The invention pertains to biometric identification of individuals using subcutaneous vein pattern recognition, through infrared imaging of a portion of the body, most typically a portion of the hand.

### BACKGROUND OF THE INVENTION

Biometric identification of individuals represents a small but rapidly growing commercial market. It has been estimated that the market for biometric sensors and systems will reach $4 billion by 2008. Motivations for increased use of biometric identification include any anti-terrorist screening, such as screening of airline passengers and access control at government and commercial facilities, plus protection against identity theft caused by theft of financial account numbers and passwords. Regarding the latter, some major banks have installed biometric identification systems at their automated teller machines. Each user has his or her biometric identity recorded on a data card, and the pattern must be matched in real time by a biometric scan of the individual before access to the bank account is allowed. The term “data card” herein is meant to be a generic description for any type of digital information storage media, such as magnetic media, semiconductor memory, optical media, etc., to which biometric identity data can be written once and read many times.

Multiple technologies have been developed for biometric identification of individuals, including fingerprint and retinal scans. One of the most promising methods of biometric identification is the use of infrared imaging of the subcutaneous vein pattern of the hand. See, for example, Rice, J., Method Of And Apparatus For The Identification Of Individuals, UK Patent 2,156,127, filed Mar. 19, 1985; Clayden, Biometric Identification Of Individuals By Use Of Subcutaneous Vein Patterns, U.S. Pat. No. 5,787,185, filed Sep. 29, 1995, issued Jul. 28, 1998; and Watanabe, M, T. Endoh, M. Shiohara, S. Sasaki, “Palm Vein Authentication Technology And Its Applications”, Proc. Biometric Consortium Conf., Sep. 19-Sep. 21, 2005, Arlington, Va., USA. In more general terms, one can image the subcutaneous vein pattern of any portion of the body. The infrared sensor captures an image of the subcutaneous vein pattern, which is then analyzed by a computer or microprocessor, and compared to the image stored on the individual's data card to determine if the individual is accepted or rejected. Near infrared radiation penetrates the skin and underlying tissue to a much greater depth than visible radiation, allowing for a more detailed image of the subcutaneous vein pattern. In place of a data card which contains a stored biometric profile, the profile can be stored on a computer network, such that the individual being scanned need only enter a personal identification number. The advantages of vein pattern identification are that palm and finger vein patterns have been shown to be unique to individuals, extremely difficult to forge, and relatively easy to interpret. Even identical twins have been found to have different vein patterns in their palms and fingers. Conversely, it has been shown that a clay model of a fingerprint can fool a fingerprint scanner, yielding a false acceptance.

Another advantage of biometric identification through imaging of the hand vein pattern versus alternate technologies such as fingerprint scanning is that, in theory, the subcutaneous vein infrared imager can be implemented with a non-contact sensor, which is totally hygienic. Fingerprint scanners are inherently contact devices which rely on high resolution capacitive sensors, not optical imaging sensors. In some cultures, sensors which must be touched by everyone accessing a public facility is considered highly undesirable. One cannot be recognized by a biometric scanner while wearing a glove. Furthermore, contact sensors which must be touched by everyone accessing a public facility accumulate dirt, resulting in a loss of measurement accuracy. Certain Asian countries have been early adopters of biometric sensors, using them to control access to government and commercial buildings, and bank automated teller machines; future markets include airport security, etc. If Asia were to suffer a major outbreak of lethal bird flu or similar contagious disease, it could wreak havoc on biometric identification systems based upon contact sensors. The ideal non-contract vein pattern biometric sensor would only require the user to hold the hand suspended in the air over an infrared imager.

The largest technical challenge which one faces when attempting to design a non-contact vein pattern biometric sensor is that of focusing the target (hand) onto the infrared imager in lieu of the fact that all such biometric infrared imagers have a fixed focus. An infrared imager with fixed focus means that the target is in focus only when the target to imager distance (target range) equals a specified, fixed value. As an example, imagine attempting to photograph the text on this page with a fixed focus camera when the target (page) is held at a distance from the camera which is significantly different than the camera's fixed focus target range. This would result in a recorded image which is out-of-focus, such that one would be unable to read some or all of the words on this page. For the vein pattern biometric sensor, an out-of-focus image will result in a vein pattern which is unrecognizable, such that all individuals scanned would be rejected by the biometric identification system. The vein pattern imager's sensitivity to target range is clear from examination of the Fujitsu PalmSecure specification sheet, where the required target range is stated as 50±10 mm (PalmSecure Palm Vein Authentication System, Fujitsu Computer Products of America, Inc.). The optical components of an infrared imager module used in vein pattern biometric sensors consist of an infrared LED illuminator, a long pass infrared filter, a fixed focus lens system, and a CCD or CMOS detector array. Those components by themselves are incapable of providing data from which target range can be accurately determined. Additional electro-optical components must be added to the infrared imager module to provide data from which target range can be determined, then a means of correcting for an out-of-focus condition must be added to the biometric sensor system.

One could attempt to add an autofocus lens to a vein pattern biometric sensor similar to that included in most digital camera systems; however, that would create multiple, additional problems: (a) It is very difficult for conventional, inexpensive autofocus lens systems to provide sharply focused images at the very short target ranges (about 50 mm) and wide field of view required of a biometric imagers; (b) a high quality autofocus lens suitable for biometric applications adds significant cost to the sensor, and (c) mechanical components of inexpensive autofocus systems would wear out with the frequent use required of typical biometric sensors, such as thousands of uses per week 52 weeks per year.

The two leading companies in the field of vein pattern biometric sensors, Fujitsu and Hitachi, recognize the importance of the non-contact or touchless feature as it relates to acceptance by a broad customer base. The importance of the non-contact feature is emphasized in patents and patent applications authored by the Hitachi staff (US20050185827, U.S. Pat. No. 6,813,010, U.S. Pat. No. 6,912,045, U.S. Pat. No. 6,993,160) and the Fujitsu staff (US20050148876). However, neither Fujitsu, Hitachi, nor their competitors have been able to develop and offer for sale a truly non-contact vein pattern recognition sensor of the type described in the above-referenced patent applications.

The Hitachi Secure Vein biometric sensor images the subcutaneous vein pattern in a finger and is offered in several slightly different versions. However, each version requires the user to place his or her hand in contact with a contoured hand rest or finger rest, which fixes the target (finger) range and horizontal registration with respect to the infrared imager.

The previously referenced Hitachi patents and patent applications consist of Kono, Umemura, Miyatake, Harada, Ito and Ueki, Personal Identification System, US Patent Application Publication 2005/0185827, filed Apr. 13, 2005; Kono, Umemura, Miyatake, Harada, Ito and Ueki, Personal Identification System, U.S. Pat. No. 6,912,045, filed Dec. 12, 2003, issued Jun. 28, 2005; Kono, Umemura, Miyatake, Harada, Ito and Ueki, Personal Identification System U.S. Pat. No. 6,813,010, filed Sep. 18, 2001, issued Nov. 2, 2004; and Miura, Nagasaka and Miyatake, Personal Identification Device and Method, U.S. Pat. No. 6,993,160, filed Sep. 5, 2001, issued Jan. 31, 2006. FIGS. 2, 3, 4, and 5 of U.S. Pat. No. 6,993,160 depict several versions of a non-contact finger vein biometric sensor. In one version, the user moves the hand through a slot-shaped gap that houses the infrared radiation source on one side of the gap, and the infrared camera on the opposite side; in the other version, the user inserts one finger into a cavity. This patent contains no discussion of target (finger) range measurement or means for correcting an out-of-focus image.

U.S. Pat. Nos. 6,813,010 and 6,912,045 and US Patent Application Publication 2005/0185827 are very similar, in that none of the claims describe non-contact operation; and none of the claims describe a rangefinder or means of correcting for an out-of-focus image. Many of the claims explicitly describe supporting the finger with a physical structure. Specifications for all three patents or patent applications contain the statement: “Because a fully non-contact method is not always advantageous in cost, processing time, and compactness, it is more practical for a device, while retaining the non-contact features described above, to have the minimum positioning parts required for fixing an imaging region such as a finger or a hand”. Hence, the authors state that fully non-contact operation is desirable, because it “reduces the possibility of bacillus contagion caused by an unspecified number of persons using the device”. However, they were unable to specify a practical, cost-effective, compact means of implementing a fully non-contact design. Specifications for all three of these patents and applications also contain the statement: “An optical sensor, which measures the distance between the device and the palm to check to see if the height from the device to the palm is correct is provided to control the image capturing. If the height is incorrect, incorrect height information is sent to the identifiee.” However, the specifications do not provide any design details whatsoever as to how one night construct a practical, cost-effective, compact optical rangefinder for use with a vein pattern biometric sensor. The authors did not describe any optical rangefinder design, and none have been incorporated into the Hitachi products.

The Fujitsu biometric sensor, the PalmSecure, images the subcutaneous vein pattern of the palm of the hand; the newest version of which was introduced in March 2006. The product literature pictures an individual holding a hand horizontally flat above the imager, suspended in the air, with the palm facing down. However, the product literature does not describe any means by which the target range is measured, nor means by which the user is guided to place the palm at the required target range (50±10 mm) as given in the sensor's specification sheet. The PalmSecure does not have a target range measurement capability. Limitations of the PalmSecure were clearly evident when the inventor attended the American Health Information Management Association Tradeshow in the Colorado Convention Center, Denver, Colo., on Oct. 10, 2006. At that Tradeshow, the Fujitsu staff provided the inventor with a demonstration of PalmSecure connected to a notebook personal computer. To properly demonstrate the PalmSecure, the Fujitsu staff had to utilize a pop-up hand rest or cradle, which is not pictured in the PalmSecure literature. The hand rest fixed the hand at a well-defined range and horizontal registration by supporting the wrist and each finger individually in slots. When the inventor asked the Fujitsu staff how one might use the PalmSecure in the preferred, non-contact mode, the answer given was that the infrared imager has some distance sensitivity, and that a user learning curve was required to achieve reliable operation in the advertised, non-contact mode. The Fujitsu staff member, who was far more experienced with the PalmSecure than the average user, was unable to demonstrate operation without the use of a hand rest. Indeed, operation without the hand rest in the advertised non-contact mode was never even attempted during the Oct. 10, 2006 Tradeshow demonstration. The PalmSecure was connected to a notebook computer, and the computer display provided no guidance regarding how the individual being scanned should position the hand above the infrared imager.

The previously referenced Fujitsu patent application is Endoh, Aoki, Goto and Watanabe, Individual Identification Device, US Patent Application Publication 2005/0148876, filed Feb. 1, 2005, as a continuation of a PCT Application filed Sep. 3, 2002. Claim 1 of US2005148876 describes “An imaging device which can image blood vessels of a hand without coming into contact with the hand, comprising: a position/direction/shape instructing unit for instructing a user to hold up his hand; . . . ”. Claim 1 is quite ambiguous regarding design and operation of the instructing unit, and none of the figures provide any clue as to how the instructing unit operates. However, claim 13 provides more clarity: “The individual identification device according to claim 1, comprising: a detection unit for detecting the position and/or direction of a hand from the photographed image of the hand each time a blood vessel image is detected; a judgment unit for judging whether the detected position and/or direction of the hand is appropriate; and a notification unit for notifying the user that the position and/or the direction of the hand is inappropriate when the position and/or the direction of the hand is inappropriate”. It is clear from claim 13 that the position and/or direction of the hand is measured directly from the photographed image of the hand, which means that the horizontal position or rotation of the hand is measured with image pattern recognition software. For a truly non-contact vein pattern biometric sensor, the most important parameter which must be measured is that of target range; and target range cannot be determined directly from the photographed image. The fact that the Fujitsu PalmSecure could not be operated in a truly non-contact mode during the Oct. 10, 2006 Tradeshow demonstration, and the fact that the notebook computer screen gave the user no guidance with respect to target range, shows that the PalmSecure does not measure target range and that the biometric sensor design described in US2005148876 has never yielded a practical non-contact vein pattern biometric sensor.

The original research in hand vein pattern recognition stresses the importance of using a physical support in contact with portions of the hand to define the target range and horizontal registration of the target with respect to the infrared imager. For example, Clayden (FIG. 1), referenced above, described a method for imaging the subcutaneous veins in the back of the hand by requiring that the individual grip a positional reference handle, then move the hand laterally until it was in contact with a side stop. The physical supports were considered crucial to obtaining precise, accurate, repeatable results. The analysis of Clayden was based upon fundamental optical measurement theory, which has not changed. However, physical supports in contact with the hand are incompatible with the non-contact design goal for hand vein imagers. It is evident from the above that there has long been a need felt in the art for an imaging device which can image blood vessels of either the palm or finger of a hand without coming into contact with the hand, but a workable device that can provide such contactless imaging is not yet available.

### BRIEF SUMMARY OF THE INVENTION

The present invention solves the problem described above and advances the art by providing an innovative, low cost, electro-optical method and apparatus, with no moving parts, yielding the first truly non-contact hand vein biometric sensor, wherein measurement errors caused by uncertainties in the target range and horizontal registration have been eliminated. In the preferred embodiment, the additional electro-optical components which must be added to the infrared imager module consist of a low power laser diode, a collimating lens or mirror, and laser driver circuitry, the sum of which costs approximately ten dollars, for high volume applications. Preferably, the target is a palm, back or a hand, or finger. Preferably, a single laser diode (LD) illuminates the target in such a way that the pattern of reflected radiation, when viewed by a conventional vein pattern infrared imager, provides a direct measure of target range. Real time analysis of this reflected radiation pattern is used to create a visual or audio signal that instructs the individual being scanned to move the hand in such a way as to precisely place it at the optimum range. Indeed, the individual being scanned preferably is directed to position the hand at the same range as that recorded on his or her biometric identity data card, thus substantially reducing the false rejection rate. Herein, false rejection rate is the rejection rate for individuals whose true identity matches that recorded on their biometric data cards. Reduction of the false rejection rate permits the tightening up of the parameters in the pattern recognition software in such a way as to also reduce the false acceptance ratio, i.e., the acceptance ratio of individuals whose true identity does not match that recorded on the biometric data card in their possession.

Yet another embodiment of the invention consists of using ultrasonic emitters and sensors to measure the target range and horizontal registration, then create visual or audio instructions for the individual being scanned to move the hand in such a way as to precisely position it at the optimum range. Yet another embodiment of the invention consists of using a passive optical range finder to measure the target range, then create visual or audio instructions for the individual being scanned to move the hand in such a way as to precisely position it at the optimum range. A passive optical range finder is one which does not require the use of any laser diodes, or any means of target illumination other than that which already exists in conventional vein pattern infrared imagers.

The invention provides a method of biometric vein imaging, the method comprising: placing a target portion of a human body in a position where it can be scanned by a biometric imager; electronically determining whether the target is located within a predetermined location range with respect to the imager, providing a signal indicating either that the target is within the predetermined location range or how it must be moved to get within the range; and when it is determined that the target is within the predetermined range, scanning the target with the biometric imager. Preferably, the scanning comprises scanning with a vein imager. Preferably, the placing comprises placing a human finger, a palm of a hand, or a back of a hand. Preferably, the placing comprises aligning the finger or palm with one or more guidelines. Preferably, the one or more guidelines are formed on or slightly above a surface on which the imager is mounted. Preferably, there are two of the guidelines and the guidelines are orthogonal to each other. Preferably, the placing comprises placing the target portion of the human body in accordance with visual instructions. Preferably, the visual instructions include one or more drawings or photographs. Preferably, the visual instructions depict a hand which has been positioned correctly above the imager as viewed from the side of the hand and as viewed from the top of the hand. Preferably, the electronically determining comprises directing light at the target. Preferably, the directing comprises directing a laser beam or light emitting diode beam at the target. Preferably, the directing a laser beam comprises directing a red visible laser beam at the target. Preferably, the electronically determining comprises electronically determining whether the target is within a predetermined distance range from the imager. Preferably, the electronically determining comprises detecting radiation reflected by the target with a charge coupled detector (CCD) or CMOS detector array. Preferably, the detecting comprises pulsing the light synchronous with the CCD or CMOS detector frame rate. Preferably, the method further comprises computing the difference between sequential CCD or CMOS frames. Preferably, the directing comprises directing a plurality of laser or light emitting diode beams at the target. Preferably, the providing a signal comprises providing a visual or an aural signal. Preferably, the providing comprises providing a visual signal utilizing one or more light emitting diodes (LED). Preferably, the utilizing comprises using a green diode to indicate the target is within the predetermined location range and using one or more red diodes to indicate how the target must be moved to get within the range. Preferably, the electronically determining comprises detecting radiation reflected from the target and using real time analysis of the reflected radiation to provide the signal. Preferably, the target is a human finger, a human palm of a hand, or a human back of a hand, and the providing comprises instructing the human being to move the finger or hand in such a way as to place it at either the optimal distance range or the optimal horizontal registration with respect to the imager. Preferably, the electronically determining is performed using only radiation provided by the biometric imager. Preferably, the electronically determining comprises directing sound energy at the target and utilizing reflected sound energy to provide the signal.

The invention also provides a biometric imaging system for recording a vein pattern of a target portion of a human body, the system comprising: a source of energy directed at the target; a detector located to detect a portion of the energy which is reflected from the target; a computer for performing real time analysis of the reflected energy, for generating a signal indicative of the range of the target, and for providing a vein pattern image of the target; and a visual or aural output device responsive to the signal for providing instructions to assist in placing the target within a predetermined location range with respect to the detector. Preferably, the source of energy comprises a light emitting diode (LED) or a laser. Preferably, the source of energy comprises a laser diode. Preferably, the source of energy is a source of red visible light. Preferably, the detector is a charge coupled detector (CCD) or CMOS detector. Preferably, the energy source is a pulsed source of light synchronized with the detector frame rate of the CCD or CMOS detector. Preferably, the system further includes a visual aid for proper placement of the target portion of the human body with respect to the imaging system. Preferably, the visual aid includes one or more drawings or photographs showing proper placement of the target portion of the human body with respect to the imaging system. Preferably, the one or more drawings or photographs depict a hand which has been positioned correctly above the imager as viewed from the side of the hand and as viewed from the top of the hand. Preferably, the system further includes one or more guidelines for assisting in locating the target portion of the human body with respect to the imaging system. Preferably, the system further includes instructions for using the guidelines to correctly locate the target portion of the human body with respect to the imaging system. Preferably, there are two of the guidelines and the guidelines are orthogonal to one another. Preferably, the target portion of the human body is a human finger, a human palm of a hand, or a human back of a hand, and the one or more guidelines assist in locating the tip of the middle finger. Preferably, the visual aid comprises one or more light emitting diodes (LED). Preferably, the visual aid includes a green diode to indicate the target is within a predetermined location range and one or more red diodes to indicate how the target must be moved to get within the predetermined range. Preferably, the source of energy comprises a collimating lens or mirror or a focusing lens or mirror. Preferably, the source of energy comprises a lens or mirror producing a Gaussian beam profile. Preferably, the source of energy comprises a lens or mirror producing a collimated beam.

The invention provides for the first practical system for placing the body part being imaged at an accurate location with respect to the imager without the use of any sort of physical constraint or hand rest. Numerous other features, objects, and advantages of the invention will become apparent from the following description when read in conjunction with the accompanying drawings.

### BRIEF DESCRIPTION OF THE DRAWINGS

FIG. 1 shows a view of the palm vein biometric identification system according to the invention, looking down on the back of the right hand, with an LED display, instruction block, and photographs to the left of the hand, and alignment marks near the tip of the middle finger,

FIG. 2 shows a schematic representation of the first preferred embodiment for a low cost rangefinder for a palm vein imager according to the invention, implemented with a single LD (laser diode), with the hand placed at the optimum vertical distance above the infrared imager;

FIG. 3 shows the embodiment of FIG. 2 with the hand placed at a vertical distance less than the optimum distance;

FIG. 4 shows the Gaussian beam profile for a focused laser beam, the shaded area is that occupied by the laser beam, and the y-axis distance between the two solid lines representing the laser beam width;

FIG. 5 shows a schematic representation of the second preferred embodiment for a low cost laser rangefinder for a palm vein imager according to the invention, implemented with a single LD, with the hand placed at the optimum vertical distance above the infrared imager;

FIG. 6 provides a schematic representation of the preferred embodiment of a biometric vein pattern identification system according to the invention, including digital image analysis, human interface, and biometric data interface;

FIG. 7 shows a view of the finger vein biometric identification system according to the invention looking down on the back of the right hand, with an LED display, instruction block and photographs to the left of the hand, and alignment marks near the tip of the middle finger;

FIG. 8 shows a schematic representation of the first preferred embodiment for a low cost rangefinder for a finger vein imager according to the invention, implemented with a single LD (laser diode), with the finger placed at the optimum vertical distance above the infrared imager; and

FIG. 9 shows a schematic representation of the second preferred embodiment for a low cost laser rangefinder for a finger vein imager according to the invention, implemented with a single LD, with the finger placed at the optimum vertical distance above the infrared imager.

### DETAILED DESCRIPTION OF THE INVENTION

### 1. Preferred Embodiment for Palm Vein Pattern Identification

This detailed description of the preferred embodiment describes an electro-optical system and method for improved performance of subcutaneous vein pattern imagers for biometric identification, preferably hand vein imagers, and still more preferably palm vein imagers. Those skilled in the art can easily adapt the electro-optical devices described in this section to subcutaneous vein pattern imagers designed to scan other parts of the human body. Hand vein imagers include imagers that image the veins in any portion of the hand, including the palm of the hand, the back of the hand, or the front or back of any of the fingers.

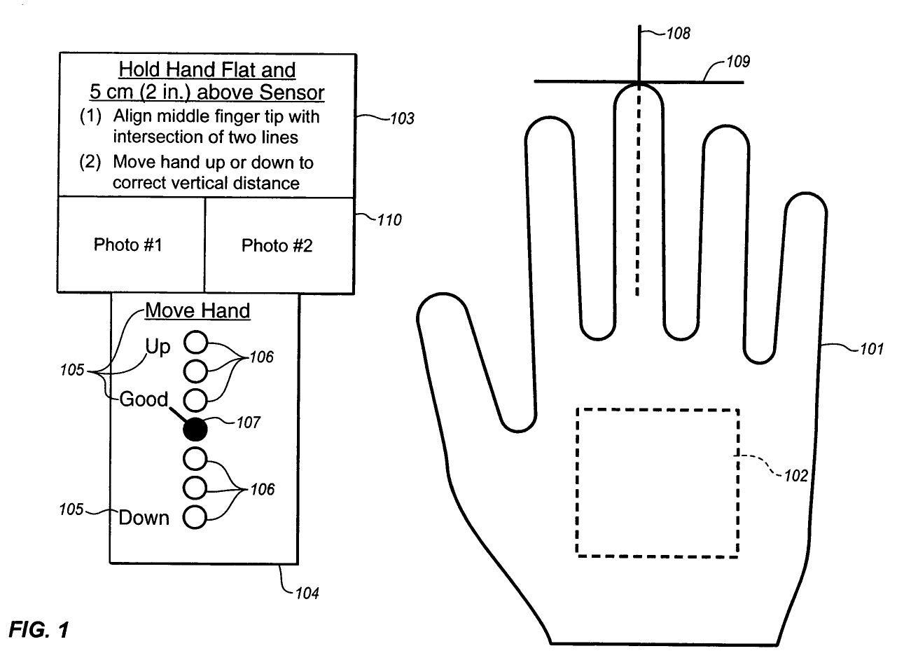

FIG. 1 depicts how the biometric identification system appears to the individual being scanned; it shows a view looking down on the back of the right hand 101. The infrared imager module 102 is beneath the hand and, therefore, is depicted by the dashed lines. To the left of the hand is an instruction block 103, a photo block 110, and an LED module 104, all of which are mounted on the same table surface as the infrared imager module 102; the table surface is typically 90-95 cm above floor level. The instruction block 103 informs the individual being scanned to “Hold Hand Flat And 5 cm (2 in) Above Sensor”. The instruction block 103 then instructs the individual to “(1) Align middle finger tip with intersection of two lines,” and “(2) Move hand up or down to correct vertical distance”. Two guidelines 108 and 109 are provided, preferably located on or slightly above the surface on which the infrared imager module is mounted; the portion of line 108 which is beneath the middle finger has been depicted as a dashed line. Preferably, the guidelines are orthogonal to one another. One line 109 provides guidance for positioning the finger in one horizontal direction corresponding to the vertical direction in FIG. 1, and the other line 108 provides information for orienting the finger in the other horizontal direction corresponding to the horizontal direction in FIG. 1. Alternatively, this may be considered as the alignment of the tip of the finger with the intersection of the two lines, orients the hand to the point of intersection, and the alignment of the middle finder along the line 108 rotationally orients the hand with respect to the point of intersection. The block 110 contains one or more depictions of a correctly placed hand. Preferably, there are two such depictions, which may be drawings or photographs which have been formed on a durable surface, such as by printing. The two drawings or photos preferably depict a hand which has been positioned correctly above the infrared imager module, as viewed from the side of the hand and as viewed from the top of the hand. These two photos substantially improve the biometric identification system's ease of use. For instance, the view from the side of the hand clearly depicts what is meant by “hold hand flat”, and the view from the top of the hand clearly depicts what is meant by “align middle finger tip with the intersection of two lines”. The method and apparatus depicted in FIG. 1 places the hand at the approximately correct horizontal registration or position with respect to the infrared imager module. The horizontal registration of the hand need not be perfect; it only needs to be accurate enough such that the portion of the hand vein pattern used for biometric identification is within the field of view of the infrared imager. Small errors in horizontal registration or horizontal positioning of the hand can be routinely corrected by state-of-the-art image analysis software, as is routinely done in fingerprint biometric sensors.

There exists a range of finger and hand lengths amongst individuals. Therefore, when the tip of the middle finger is aligned with the guidelines 108 and 109, slightly different portions of the palm will be aligned directly above the infrared imager module 102. However, this variance in horizontal registration of the hand is of no significance, because each master infrared scanner system used to photograph the vein pattern recorded on an individual's biometric identification card will have the exact same geometry as all point-of-use infrared scanner systems used for biometric identification of individuals. Therefore, each point-of-use scanner will view the same portion of the palm as viewed by each mast scanner.

The “5 cm (2 in) above” portion of the instruction block 103 represents the target-to-sensor focal distance for a typical infrared imager. This portion of the instruction block is intended to guide the individual to place the hand at the approximately correct target range, that is, within the dynamic range of the optical rangefinder; by “approximate”, one can safely predict that instruction block 103 will result in target distance errors of less than ±60%, which in this example would be 50±30 nm. In the absence of a rangefinder and instructing means or a physical hand support, placing the hand at precisely the correct target range to obtain good focus of the hand vein pattern onto the infrared imager is extremely difficult. Note that in FIG. 1 the individual being scanned cannot see the infrared imager. Obviously, a non-contact infrared imager which lacks a rangefinder and instructing means provides the user with no guidance regarding the correct target range. Without a rangefinder and instructing means, a large percentage of users will not be able to hold their hand at the correct target range on a repeatable basis. Specifications for state-of-the-art palm vein imagers typically state a target range of 50±10 mm (±20%) and could provide lower biometric identification error rates if the target range uncertainty were further reduced.

The seven LED module 104 contains elements which instruct the individual to move the hand up or down for improved target range definition with respect to the infrared imager. Those elements include: (a) the words 105, “Move Hand, Up, Down, Good”; (b) the six red LEDs 106 indicating incorrect positioning of the hand; and (c) the single green LED 107, indicating correct positioning of the hand. If the hand is correctly positioned, only the center green LED 107 is lit. If the hand is not correctly positioned, one of the red LEDs 106 are lit. The six red LEDs 106 indicate that the hand is not optimally positioned, and instructs the user which direction and how far to move the hand. The seven LED display module 104 is only one of many possible visual displays which can be used to instruct the individual in optimum placement of the hand, a computer screen graphical display would be another option. Alternatively, the individual could be instructed by a computer-generated voice to position his or her hand in an optimum fashion. However, the multi-element visual display module 104, which provides both directional guidance and positional resolution, represents the preferred embodiment for a stand alone biometric identification station which does not require a local computer or computer display.

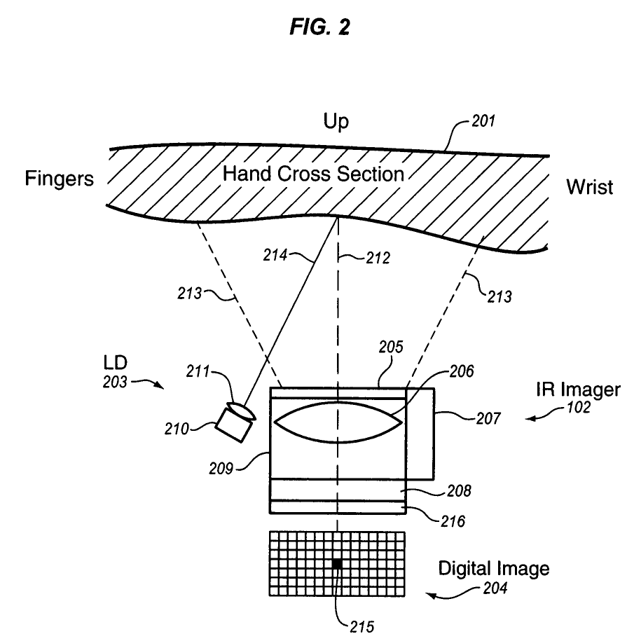

FIG. 2 shows the cross-section of a hand 201 as it is held flat above the infrared (IR) imager module 102 and laser diode module 203. Also depicted in FIG. 2 is the two-dimensional digital image 204, which is output by signal processing electronics embedded in the infrared imager module. The palm of the hand faces downward, and faces the IR imager module 102 and laser module 203. The infrared imager module 102 includes a two-dimensional CCD or CMOS detector array 208; a lens or mirror system 206 to focus the hand onto the detector array; a long pass infrared filter 205 which prevents visible radiation from reaching the detector array, thus reducing background illumination; an IR LED sub-module 207 to illuminate the hand and subcutaneous vein pattern; signal processing electronics 216; and a sensor housing 209. The LED sub-module 207 contains multiple target illuminating IR LEDs which typically emit radiation at 740-780 nm; the long pass infrared filter 205 typically transmits radiation at wavelengths greater than 700 nm.

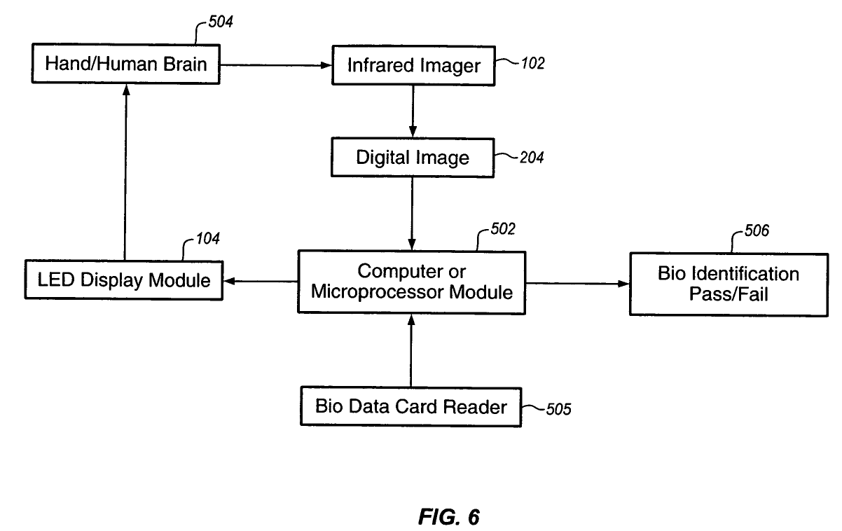

FIG. 2 depicts a low cost system for measuring the target range, that is, the distance from the palm to the infrared imager, such that the computer or microprocessor shown in FIG. 6 can interpret the range information, then use that information to drive the LED display 104 (FIG. 1), which instructs the user to move the hand up or down, such that the hand is positioned at the optimum range. The optimal range represents the best focus for the hand vein imager. The preferred embodiment utilizes a laser diode (LD) module 203, consisting of a red ID 210, emitting at 655-660 nm, such as the Hitachi HL6501MG, and a collimating lens or mirror 211. Alternatively, a light emitting diode could also be used instead of a laser. The collimated laser beam 214 strikes the surface of the palm, and thereby produces a red visible light spot that is imaged onto the detector array 208 and appears as image spot 215 in the digital image 204. The term “collimated” means that the laser beam diameter is approximately the same, independent of distance from the LD. The dashed lines 213 depict the limits of the infrared imager field of view, and the dashed line 212 depicts the optical axis in the center of that field of view. For example, as shown in FIG. 2, the LD and collimating lens are aligned such that when the palm is at the optimum distance (range) from the IR imager, the collimated laser beam strikes the surface of the palm at the center of the IR imager's field of view. In this scenario, the laser light spot reflected from the palm is imaged onto the detector and appears as image spot 215 in the center of the digital frame 204. In this example, the computer or microprocessor used for vein pattern image analysis (FIG. 6), would drive the LED display 104 to indicate that the hand is at the correct height (range).

The red visible LD radiation doesn't penetrate the skin as effectively as infrared LED or LD radiation; hence, the red visible LD provides sharper range definition by reflection at the skin surface. The skin surface does not provide as sharp of an image of the reflected red ID spot, as will be seen when the target is a piece of paper or other solid object; however, the red laser spot reflected from the skin surface is sufficiently sharp as to accurately define the target range to within much better accuracy than the ±1 cm specification given for state-of-the-art palm vein imagers; range definition with the red ID is better than 0.5 cm. For the CCD or CMOS detector array to be able to measure radiation from the red visible ID which is reflected off the skin's surface, the imager module long pass filter 205 must be changed to allow transmission of wavelengths greater than 650 nm, as opposed to the typical 700 nm This small change in filter cutoff wavelength does not adversely affect the performance of the imager module.

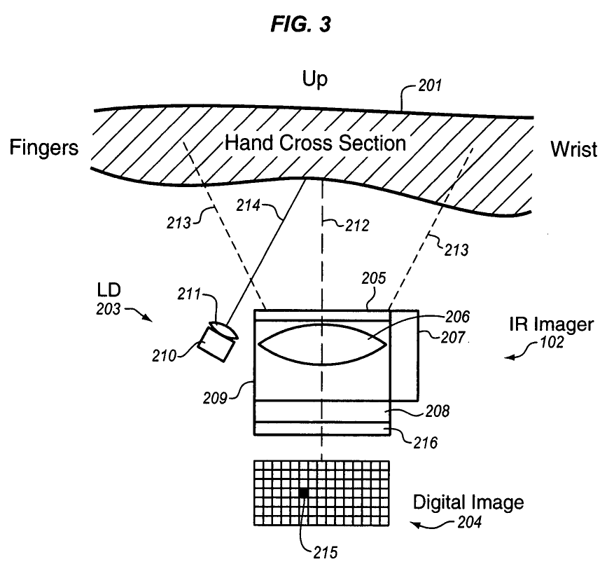

FIG. 3 is exactly the same as FIG. 2, except for the fact that the hand has been positioned at a range which is less than the optimum range. This causes the collimated red laser beam to strike the hand to the left of the infrared imager optical axis, which causes the image 215 of the red laser light spot reflected off the palm to appear to the left of center in the digital image. The distance of the red laser spot image 215 from the center of the digital image is directly proportional to the range error, or the distance which the hand must be moved upward to arrive at the optimum range. This straight forward analysis of the digital image by the image analysis computer or microprocessor shown in FIG. 6 provides the necessary information to drive the LED display 104 of FIG. 1. The LED display 104 will be driven to indicate that the hand must be moved upward, and approximately how far.

Conversely, it is easy to see that if the hand is positioned at a range which is greater than the optimum range, the image 215 of the red laser light spot reflected off the palm will appear to the right of center in the digital image. In this scenario, straight forward analysis of the digital image will cause the LED display 104 to be driven such as to indicate that the hand must be moved downward, and approximately how far.

In the preferred embodiment, the red visible LD is pulsed, synchronous with the CCD/CMOS detector frame rate. This effectively allows for AC coupling of the CCD/CMOS detector, thus eliminating the effects of constant or slowly varying background radiation. When the difference between sequential CCD/CMOS frames is computed by the attached computer or microprocessor (shown in FIG. 6), the pulsed red visible light reflected from the skin will clearly stand out from slowly varying background radiation, even at very low LD power levels, consistent with eye safety regulations. If the frames are numbered according to the time sequence in which they were recorded, such as frames 1, 2, 3, 4, etc., where 1 is the first frame recorded, then the frame differencing scheme consists of computing the difference between frames 1 and 2, the difference between frames 2 and 3, etc. A preferred sequence of events for operating the improved subcutaneous hand vein pattern imager equipped with the laser rangefinder shown in FIGS. 2 and 3 is given below. Those skilled in the art would recognize that there exist several alternate sequences of events which can be utilized. A preferred sequence comprises:
(1) The pulsed red visible LD is normally powered on, which represents the target acquisition mode.
(2) The CCD/CMOS detector with associated computer or microprocessor continually examines the AC signal, which is computed from subtracting sequential image frames. The presence of a target suspended near the vein pattern sensor is easily detected by recognizing the presence of a reflected LD light spot from the target when the reflected spot is within the detector field of view.
(3) By visual or audio signals, the individual being scanned is directed to move the hand to the optimum target range above the vein pattern sensor.
(4) When the hand is positioned at the optimum target range, the pulsed red visible LD is powered off so that it doesn't interfere with vein pattern image acquisition.
(5) The infrared LEDs of the imager module are powered on, the image of the subcutaneous vein pattern is captured, and this real time vein pattern image is compared with that recorded on the individual's biometric data card. The biometric identification system then either accepts or rejects the individual.

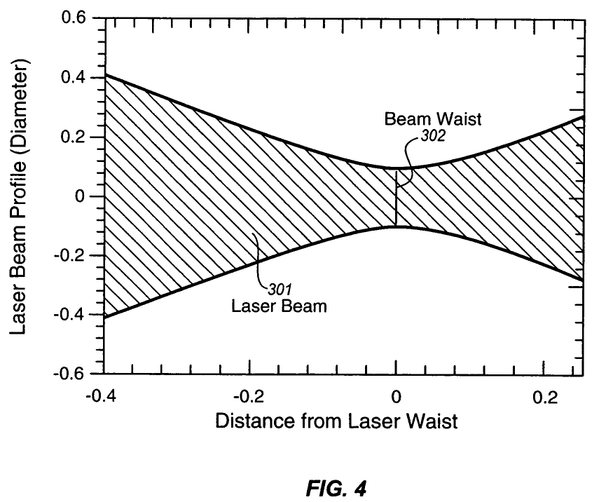

There exists a second preferred design of a laser rangefinder for a biometric vein pattern imager based upon a single LD. In this second preferred embodiment, the image analysis is somewhat more complicated; however, it offers the advantage that the laser rangefinder beam need not be aligned at a precise angle with respect to the vertical axis of the infrared imager. FIG. 4 depicts the principle of operation for this alternative laser rangefinder design based upon the relationship between laser beam diameter and distance (range to the target). FIG. 4 is an accurate graphical representation of the Gaussian beam profile for a focused laser beam 301. The beam diameter reaches a minimum at the focal point or beam waist 302, then expands or diverges downstream of the beam waist. The increase in beam diameter with distance is initially non-linear, then asymptotically approaches a linear function as one gets farther from the beam waist 302. When a hand is inserted into the divergent laser beam at a range greater than the laser waist, the diameter of the reflected spot size imaged onto the infrared vein pattern imager is directly proportional to the distance from the laser beam waist 302, which is a direct measure of target range.

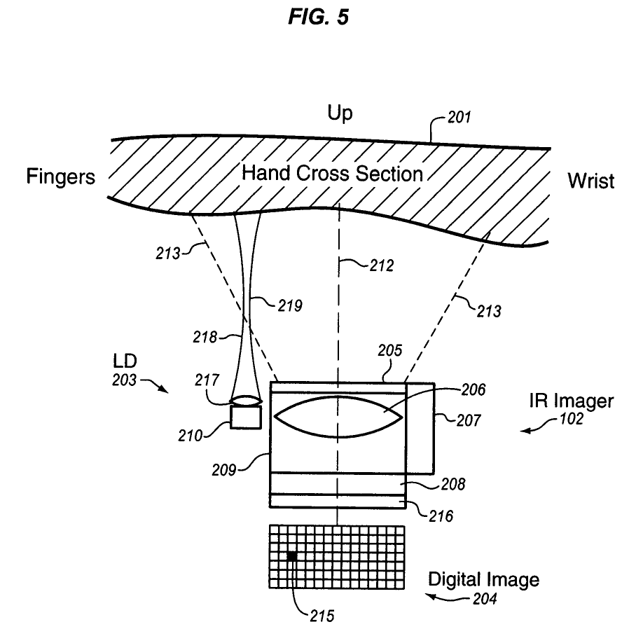

FIG. 5 depicts implementation of the second preferred embodiment of a laser rangefinder in a biometric imager for palm vein pattern recognition. FIG. 5 is similar to FIG. 2, with the differences being that: (a) the laser beam 218 is now focused to a waist 219 by a focusing lens 217 at a distance less than the minimum target range rather than being collimated; and (b) the laser beam is now approximately vertical rather than tilted at an angle with respect to the vertical optical axis 212 of the infrared imager. In this second preferred embodiment of a laser rangefinder, the position of the reflected laser light spot 215 in the digital image 204 is not the significant aspect. It is the diameter of the reflected laser light spot in the digital image which yields a direct measure of the range to the target. Based upon the previous example for the first preferred embodiment, and given the guidance from instruction block 103 of FIG. 1, the minimum target range is 40% of 50 mm, or 20 mm. In this previous example, the optimum target range is 50 mm, which results in a measured reflected laser spot diameter D2, as determined on the digital image by the computer or microprocessor module 502 of FIG. 6. If the hand is held at a target range less than optimal in the divergent laser beam, this yields a reflected spot diameter D1 which is less than D2; this fact is used to drive the LED display 104 to indicate that the hand is positioned lower than optimal and must be moved upwards. Conversely, when the hand is held at a target range greater than optimal in the divergent laser beam, this yields a reflected spot diameter D3 which is greater than D2; this fact is used to drive the LED display 104 to indicate that the hand is positioned higher than optimal and must be moved downwards.

One also could focus the laser beam such that the waist occurs at a target range greater than the maximum target range of 160% of 50 mm, or 80 mm. In this scenario, the hand would always intercept a convergent laser beam. The diameter of the reflected spot size appearing in the digital image 204 would again yield a direct measure of the target range; however, the diameter of the spot would be inversely proportional to the target range, and a smaller spot diameter would be indicative of a larger target range.

FIG. 6 is a schematic depiction of the preferred vein pattern recognition biometric identification system. The infrared imager module 102 acquires a digital image 204 and passes it to the computer or microprocessor module 502, which in turn drives the LED display module 104, which drives the human brain/hand 504, which causes the human hand to change the target range, which yields a closed loop feedback through the infrared imager module 102 until the hand (target) is moved to the optimum range. Additionally, the biometric data card reader 505 provides input to the computer or microprocessor module 502, which compares the vein pattern stored on the bio data card with the biometric scan of the individual's subcutaneous vein pattern. The final system output is a pass/fail 506 on biometric identification, which can be communicated to a user with a visual or audio display and/or communicated to a computer network A biometric pass or positive identification allows the individual to access secure devices, data files, buildings, bank accounts, aircraft, etc.

### 2. Preferred Embodiment for Finger Vein Pattern Identification

The preferred embodiments for finger vein pattern identification are similar to the preferred embodiments for palm vein pattern identification, with minor modifications.

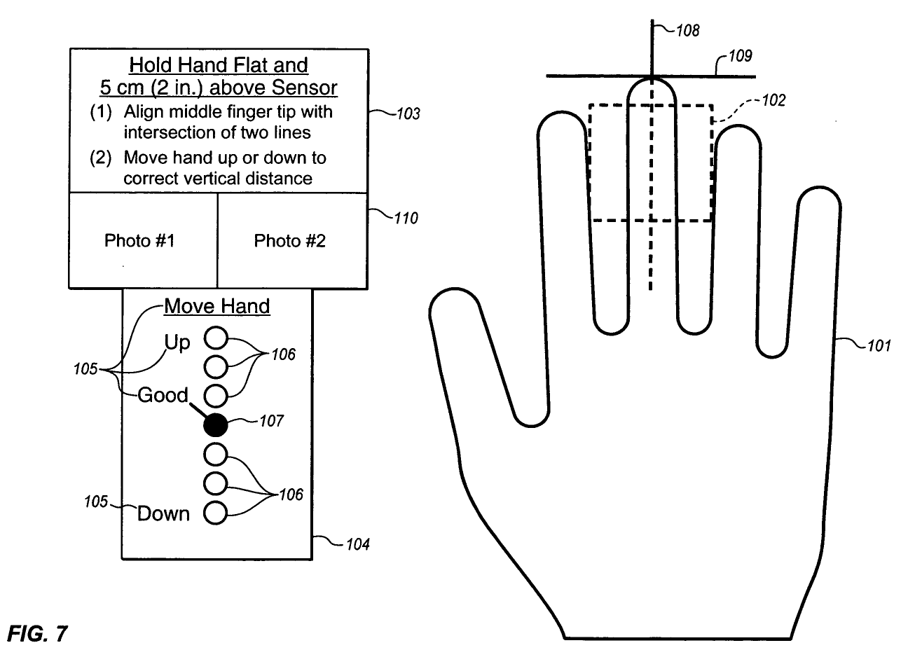

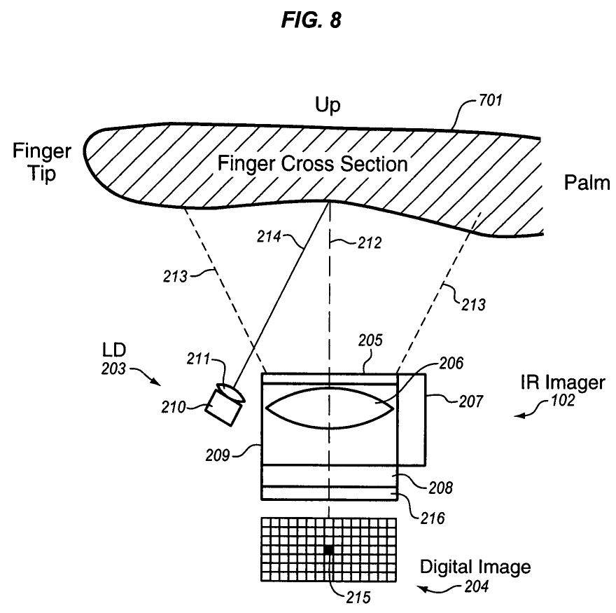

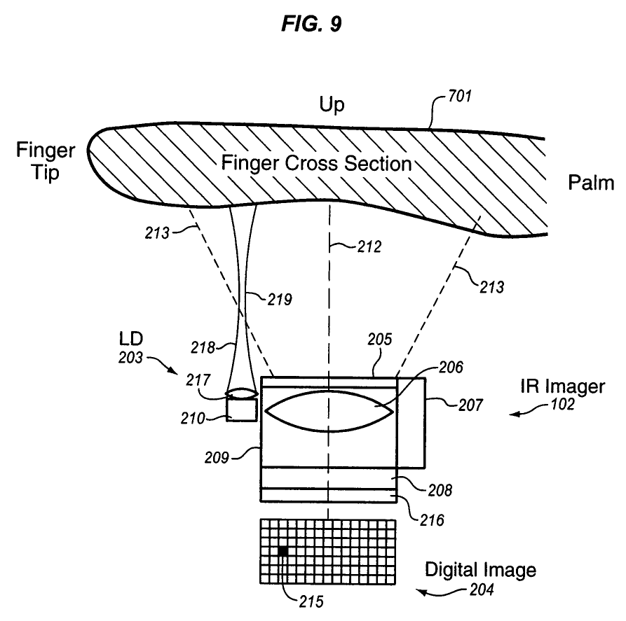

FIG. 7 is a slightly modified version of FIG. 1, the only difference being that the infrared imager module 112 is now centered under the middle finger which vein pattern is utilized for biometric identification. The instruction block 103 preferably is modified to include the message that the red light from the rangefinder ID shown in FIG. 8 or FIG. 9 is not visible to the individual being scanned when the finger is positioned at the correct horizontal registration.

FIG. 8, a slightly modified version of FIG. 2, shows the cross-section of a finger 701 as it is held flat above the infrared (IR) imager module 102 and laser diode module 203. Also depicted in FIG. 8 is the two-dimensional digital image 204, which is output by signal processing electronics embedded in the infrared imager module. The palm of the hand faces downward and faces the IR imager module 102 and laser module 203. The infrared imager module 102 includes a two-dimensional CCD or CMOS detector array 208; a lens or mirror system 206 to focus the finger onto the detector array, a long pass infrared filter 205 which prevents visible radiation from reaching the detector array, thus reducing background illumination; an IR LED sub-module 207 to illuminate the finger and subcutaneous vein pattern; signal processing electronics 216; and a sensor housing 209. The LED sub-module 207 contains multiple target illuminating IR LEDs. In this scenario, the laser light spot reflected from the finger is imaged onto the detector and appears as image spot 215 in the center of the digital frame 204. In this example, the computer or microprocessor used for vein pattern image analysis (FIG. 6) would drive the LED display 104 to indicate that the finger is at the correct height (range).

If the finger were positioned at a distance less than the optimum target range similar to the scenario depicted in FIG. 3, then the reflected laser light spot would be positioned to the left of the infrared imager optical axis, which causes the image 215 of the red laser light spot to appear to the left of center on the digital image. The LED display 104 will be driven to indicate that the hand must be moved upward and approximately how far.

Conversely, if the finger is positioned at a range which is greater than the optimum range, the image 215 of the red laser light spot reflected off the finger will appear to the right of center in the digital image. In this scenario, straight forward analysis of the digital image will cause the LED display 104 to be driven such as to indicate that the hand must be moved downward and approximately how far.

FIG. 9 is a slightly modified version of FIG. 5 and depicts implementation of the second preferred embodiment of a laser rangefinder in a biometric imager for finger vein pattern recognition. FIG. 9 is also similar to FIG. 8, with the only differences being that: (a) the laser beam 218 is now focused to a waist 219 by a focusing lens 217 at a distance less than the minimum target range rather than being collimated; and (b) the laser beam is now approximately vertical rather than tilted at an angle with respect to the vertical optical axis 212 of the infrared imager. In this second preferred embodiment of a laser rangefinder, the position of the reflected laser light spot 215 in the digital image 204 is not significant. Rather, it is the diameter of the reflected laser light spot in the digital image which yields a direct measure of the range to the target. Based upon the previous example for the first preferred embodiment and given the guidance from instruction block 103 of FIG. 1, the minimum target range is 40% of 50 mm, or 20 mm. In this previous example, the optimum target range is 50 mm, which results in a measured reflected laser spot diameter D2, as determined on the digital image by the computer or microprocessor module 502 of FIG. 6. If the hand is held at a target range less than optimal in the divergent laser beam, this yields a reflected spot diameter D1, which is less than D2; this fact is used to drive the LED display 104 to indicate that the hand is positioned lower than optimal and must be moved upwards. Conversely, when the hand is held at a target range greater than optimal in the divergent laser beam, this yields a reflected spot diameter D3, which is greater than D2; this fact is used to drive the LED display 104 to indicate that the hand is positioned higher than optimal and must be moved downwards.

One could also focus the laser beam such that the waist occurs at a target range greater than the maximum target range of 160% of 50 mm, or 80 mm. In this scenario, the hand would always intercept a convergent laser beam. The diameter of the reflected spot size appearing in the digital image 204 again would yield a direct measure of the target range; however, the diameter of the spot would be inversely proportional to the target range, and a smaller spot diameter would be indicative of a larger target range.

Those skilled in the art will realize that there exists alternative laser rangefinder designs for use with biometric vein pattern imagers; for example, a rangefinder using a plurality of LDs or a linear array of LDs. The two single laser rangefinder designs which have been described are highly accurate and are practical, straightforward, and economical; hence, they have been described in detail as the two preferred embodiments. Likewise, those skilled in the art will realize that in using the teachings there exists alternative methods and apparatus for achieving accurate horizontal registration of the hand for biometric vein pattern imaging.

There has been described a biometric identification system that is practical, cost effective, accurate, and user friendly. It should be understood that the particular embodiments shown in the drawings and described within this specification are for purposes of example and should not be construed to limit the invention, which will be described in the claims below. For example, while the embodiments have been described in terms of imaging the veins in the palm of the hand, the system can also be used for imaging veins in the back of the hand or fingers. Further, it is evident that those skilled in the art may now make numerous uses and modifications of the specific embodiment described without departing from the inventive concepts. Equivalent structures and processes may be substituted for the various structures and processes described; the subprocesses of the inventive method may, in some instances, be performed in a different order, or a variety of different materials and elements may be used. For example, an LED optical system can be substituted for the laser optical system described above. Consequently, the invention is to be construed as embracing each and every novel feature and novel combination of features present in and/or possessed by the biometric identification apparatus and methods described.

What is claimed as new and desired to be protected by Letters Patent of the United States is:

1. A method of biometric vein imaging, said method comprising:
placing a target portion of a human body in a position where it can be scanned by a biometric imager;
electronically determining whether said target is located within a predetermined location range with respect to said imager;
providing a signal indicating either that said target is within said predetermined location range or how it must be moved to get within said range; and
when it is determined that said target is within said predetermined range, scanning said target with said biometric imager.

2. A method as in claim 1 wherein said scanning comprises scanning with a vein imager.

3. A method as in claim 2 wherein said placing comprises placing a human finger, a palm of a hand, or a back of a hand.

4. A method as in claim 3 wherein said placing comprises aligning said finger or palm with one or more guidelines.

5. A method as in claim 4 wherein said one or more guidelines are formed on or slightly above a surface on which said imager is mounted.

6. A method as in claim 4 wherein there are two of said guidelines and said guidelines are orthogonal to each other.

7. A method as in claim 1 wherein said placing comprises placing said target portion of said human body in accordance with visual instructions.

8. A method as in claim 1 wherein said visual instructions include one or more drawings or photographs.

9. A method as in claim 8 wherein said visual instructions depict a hand which has been positioned correctly above said imager as viewed from the side of the hand and as viewed from the top of the hand.

10. A method as in claim 1 wherein said electronically determining comprises directing light at said target.

11. A method as in claim 10 wherein said directing comprises directing a laser beam or light emitting diode beam at said target.

12. A method as in claim 11 wherein said directing a laser beam comprises directing a red visible laser beam at said target.

13. A method as in claim 12 wherein said electronically determining comprises electronically determining whether said target is within a predetermined distance range from said imager.

14. A method as in claim 10 wherein said electronically determining comprises detecting radiation reflected by said target with a charge coupled detector (CCD) or CMOS detector array.

15. A method as in claim 14 wherein said detecting comprises pulsing said light synchronous with the CCD or CMOS detector frame rate.

16. A method as in claim 15, and further comprising computing the difference between sequential CCD or CMOS frames.

17. A method as in claim 11 wherein said directing comprises directing a plurality of laser or light emitting diode beams at said target.

18. A method as in claim 1 wherein said providing a signal comprises providing a visual or an aural signal.

19. A method as in claim 18 wherein said providing comprises providing a visual signal utilizing one or more light emitting diodes (LED).

20. A method as in claim 19 wherein said utilizing comprises using a green diode to indicate said target is within said predetermined location range and using one or more red diodes to indicate how said target must be moved to get within said range.

21. A method as in claim 1 wherein said electronically determining comprises detecting radiation reflected from said target and using real time analysis of said reflected radiation to provide said signal.

22. A method as in claim 21 wherein said target is a human finger, a human palm of a hand, or a human back of a hand, and said providing comprises instructing said human being to move said finger or hand in such a way as to place it at either the optimal distance range or the optimal horizontal registration with respect to said imager.

23. A method as in claim 1 wherein said electronically determining is performed using only radiation provided by said biometric imager.

24. A method as in claim 1 wherein said electronically determining comprises directing sound energy at said target and utilizing reflected sound energy to provide said signal.

25. A biometric imaging system for recording a vein pattern of a target portion of a human body, said system comprising:
a source of energy directed at said target;
a detector located to detect a portion of said energy which is reflected from said target;
a computer for performing real time analysis of said reflected energy, for generating a signal indicative of the range of said target, and for providing a vein pattern image of said target; and
a visual or aural output device responsive to said signal for providing instructions to assist in placing said target within a predetermined location range with respect to said detector.

26. A biometric imaging system as in claim 25 wherein said source of energy comprises a light emitting diode (LED) or a laser.

27. A biometric imaging system as in claim 26 wherein said source of energy comprises a laser diode.

28. A biometric imaging system as in claim 25 wherein said source of energy is a source of red visible light.

29. A biometric imaging system as in claim 25 wherein said detector is a charge coupled detector (CCD) or CMOS detector.

30. A biometric imaging system as in claim 29 wherein said energy source is a pulsed source of light synchronized with the detector frame rate of said CCD or CMOS detector.

31. A biometric imaging system as in claim 25, and further including a visual aid for proper placement of said target portion of said human body with respect to said imaging system.

32. A biometric imaging system as in claim 25 wherein said visual aid includes one or more drawings or photographs showing proper placement of said target portion of said human body with respect to said imaging system.

33. A biometric imaging system as in claim 32 wherein said one or more drawings or photographs depict a hand which has been positioned correctly above said imager as viewed from the side of the hand and as viewed from the top of the hand.

34. A biometric imaging system as in claim 25, and further including one or more guidelines for assisting in locating said target portion of said human body with respect to said imaging system.

35. A biometric imaging system as in claim 34, and further including instructions for using said guidelines to correctly locate said target portion of said human body with respect to said imaging system.

36. A biometric imaging system as in claim 34 wherein there are two of said guidelines and said guidelines are orthogonal to one another.

37. A biometric imaging system as in claim 34 wherein said target portion of the human body is a human finger, a human palm of a hand, or a human back of a hand, and said one or more guidelines assist in locating the tip of the middle finger.

38. A biometric imaging system as in claim 31 wherein said visual aid comprises one or more light emitting diodes (LED).

39. A biometric imaging system as in claim 38 wherein said visual aid includes a green diode to indicate said target is within a predetermined location range and one or more red diodes to indicate how said target must be moved to get within said predetermined range.

40. A biometric imaging system as in claim 25 wherein said source of energy comprises a collimating lens or mirror or a focusing lens or mirror.

41. A biometric imaging system as in claim 40 wherein said source of energy comprises a lens or mirror producing a Gaussian beam profile.

42. A biometric imaging system as in claim 40 wherein said source of energy comprises a lens or mirror producing a collimated beam.
